(19) United States
(12) Patent Application Publication
(10) Pub. No.: US 2024/0101286 A1
(43) Pub. Date: Mar. 28, 2024

(54) LATCHING SYSTEM AND METHOD FOR VTOL VEHICLES

(71) Applicant: GADFIN LTD., Rehovot (IL)

(72) Inventor: Eyal REGEV, Mazkeret-Batya (IL)

(21) Appl. No.: 18/504,762

(22) Filed: Nov. 8, 2023

Related U.S. Application Data
(63) Continuation-in-part of application No. PCT/IL2022/050478, filed on May 9, 2022.

(30) Foreign Application Priority Data
May 10, 2021 (IL) 283070

(51) Int. Cl. B64U 70/20; B64U 10/60; B64U 50/34

(52) U.S. Cl. CPC B64U 70/20; B64U 10/60; B64U 50/34; B64U 10/20

(57) ABSTRACT

A system for latching an unmanned aerial vehicle (UAV) has a first UAV for performing a mission and configured with a latchable structure; a second UAV connected to a latching mechanism for assisting the first UAV in performing the mission; and a controller for dispatching the second UAV toward the first UAV and for commanding latching of the latching mechanism with the latchable structure of the first UAV in midair in order to assist the first UAV in performing the mission. In a UAV landing method, the second UAV is dispatched towards the first UAV while a cable extending from the latching mechanism is movably connected to a landing platform; the latching mechanism becomes latched to the latchable structure of the first UAV; and the first UAV is caused to land at the landing platform by reducing a length of the cable from the latching mechanism to the landing platform.

This is a continuation-in-part application of International Patent App. PCT/IL2022/050478 filed on May 9, 2022, which claims priority from IL 283070 filed on May 10, 2021.

### FIELD OF THE INVENTION

The present invention relates to the field of aerial vehicles. More particularly, the invention relates to a latching system and method for VTOL vehicles.

### BACKGROUND OF THE INVENTION

Aerial vehicles that undertake vertical take-off and landing (VTOL) maneuvers, such as unmanned aerial vehicles (UAVs), whether rotor vehicles or fixed-wing vehicles, often have difficulty in landing accurately at a desired small-area location due to the weather disturbances, for example strong winds or the presence of precipitation that can adversely affect control of the aircraft. These difficulties are exacerbated when it is desired to land on a moving platform, such as of a truck or a ship.

Some attempts have been made to mitigate the influence of the weather disturbances during a landing maneuver by latching the aircraft to the landing platform and drawing the latched aircraft to the landing platform; however, dedicated and expensive apparatus is required to perform such a latching operation. Other disadvantages of this approach relate to the difficulty in targeting landing platform deployed latching means with respect to an object tied or otherwise secured to the aircraft and in connecting this object to the latching means. When the landing platform undergoes three-dimensional movement, for example a shipboard platform, such a latching operation is almost impossible to perform, and also poses a safety problem to the aircraft if a cable tied to the aircraft object becomes tangled with ground station fixtures.

It is an object of the present invention to provide an improved system and method for ensuring accurate landing of VTOL vehicles.

It is another object of the present invention to provide a system and method for ensuring reliable latching of VTOL vehicles prior to landing, even when a landing platform is in motion.

It is another object of the present invention to provide a system and method for ensuring safe landing of VTOL vehicles.

Other objects and advantages of the invention will become apparent as the description proceeds.

### SUMMARY OF THE INVENTION

A system for latching an unmanned aerial vehicle (UAV) comprises a first UAV adapted to perform a mission, wherein the first UAV is configured with a latchable structure which comprises two spaced bars that downwardly extend from an undersurface of the first UAV and at least one interconnecting bar which is interconnected between an end of each of said two spaced bars; a second UAV adapted to assist the first UAV in performing the mission, upon being latched together with the first UAV, wherein the second UAV is irremovably connected to a latching mechanism which is configured with a surrounding element and with an element in releasable contact with the surrounding element that yields and changes its shape from a first shape to a second shape upon being contacted by the at least one interconnecting bar of the latchable structure to initiate a latching operation therewith; a cable movably connected to a ground station that extends to, and powers, the second UAV; and a controller operable to dispatch the second UAV upwardly from the ground station toward the first UAV and to command latching of the latching mechanism connected to the second UAV with the latchable structure of the first UAV in midair while the second UAV is located below, or horizontally spaced from, the first UAV during the latching operation, wherein, following the latching operation, the yielding element assumes the first shape and is configured to, together with the surrounding element, to encircle the at least one interconnecting bar of the latchable structure and to be freely displaceable along a length of at least one interconnecting bar.

In one aspect, the latching mechanism comprises a hook provided with a spring loaded, inwardly pivoting latch and a post downwardly extending from the hook to a hub of the second UAV, the latch being configured to yield upon being contacted by the at least one interconnecting bar of the latchable structure to initiate a latching operation therewith.

In one aspect, the second UAV is considerably smaller than the first UAV and is powered without batteries.

In one aspect, the latching mechanism is adapted to assist the first UAV in landing onto a landing platform. The cable is wound about a spool mounted to the landing platform and a winch operatively connected to the spool is activatable following the latching operation to reduce a length of the cable from the spool to the second UAV during a landing maneuver.

In one aspect, the controller is operable to command operation of the first UAV to cause forcible contact between the at least one interconnecting bar of the latchable structure and the yielding element of the latching mechanism when the first UAV is separated less than a predetermined distance from the ground station.

A UAV landing method comprises the steps of providing a first UAV configured with a latchable structure which comprises two spaced bars that downwardly extend from an undersurface of said first UAV and at least one interconnecting bar which is interconnected between an end of each of said two spaced bars; providing a second UAV irremovably connected to a latching mechanism which comprises a surrounding element and with an element in releasable contact with the surrounding element that yields and changes its shape upon being contacted by the at least one interconnecting bar of the latchable structure to initiate a latching operation therewith, wherein a cable extending from an underside of said second UAV to power said second UAV is movably connected to a landing platform of a ground station; by a controller in data communication with said first UAV, said second UAV and a winch operatively connected to a spool mounted to the landing platform and about which the cable is wound, upon determining that said first UAV is separated from the ground station by less than a predetermined distance, dispatching said second UAV upwardly from the ground station towards said first UAV; by said controller, commanding controlled displacement of one or both of said first UAV and said second UAV while said second UAV is located below, or horizontally spaced from, said first UAV until the yielding element of said latching mechanism is contacted in midair by the at least one interconnecting bar of the latchable structure and the yielding element together with the surrounding element encircle the at least one interconnecting bar, to complete the latching operation between said first UAV and said second UAV; and by said controller, causing said first UAV to land at the landing platform by commanding operation of the winch to reduce a length of the cable from said second UAV to the landing platform.

In one aspect, the step of commanding controlled displacement of one or both of said first UAV and said second UAV is performed by commanding the first UAV to accelerate until the at least one interconnecting bar forcibly contacts the yielding element of the latching mechanism and the shape of the yielding element is changed in response to the forcible contact, urging the yielding element together with the surrounding element to encircle the at least one interconnecting bar.

In one aspect, the controller temporarily takes over motors and components of the first UAV until the at least one interconnecting bar forcibly contacts the yielding element of the latching mechanism.

In one aspect, the controller determines that forcible contact is made between the at least one interconnecting bar and the latch with use of a touch sensor provided with the latchable structure that transmits a corresponding signal to the controller upon being forcibly contacted.

In one aspect, the method further comprises the step of commanding the first UAV, by the controller, to stop accelerating upon completion of the latching operation.

In one aspect, all steps are performed autonomously.

In one aspect, the method further comprises the step of causing the latching mechanism to become decoupled from the latchable structure at the landing platform in anticipation of a subsequent take-off procedure by applying a force onto a dedicated implement that initiates additional forcible contact with the yielding element, whereby the shape of the yielding element is changed in response to the additional forcible contact until the yielding element ceases to encircle the at least one interconnecting bar.

A system for latching an unmanned aerial vehicle (UAV) comprises a first UAV adapted to perform a mission, wherein the first UAV is configured with a latchable structure; a second UAV adapted to assist the first UAV in performing the mission, wherein the second UAV is irremovably connected to a latching mechanism; and a controller operable to dispatch the second UAV toward the first UAV and to command latching of the latching mechanism with the latchable structure of the first UAV in midair in order to assist the first UAV in performing the mission.

An efficient latching operation is made possible when the second UAV is considerably smaller than the first UAV and is powered without batteries, such as when a cable movably connected to a ground station extends to, and powers, the second UAV.

Preferably, the latchable structure preferably extends downwardly from an undersurface of the first UAV such that at least one bar of the latchable structure is spaced downwardly from the undersurface, and the latching mechanism is configured with an element that yields and changes its shape upon being contacted by the latchable structure to initiate a latching operation therewith. The controller is operable to command operation of the first UAV to cause forcible contact between the at least one bar of the latchable structure and the yielding element of the latching mechanism when the first UAV is separate less than a predetermined distance from the ground station.

In one aspect, the latching mechanism comprises a hook provided with a spring loaded, inwardly pivoting latch and a post downwardly extending from the hook to a hub of the second UAV.

In one aspect, the latching mechanism of the second UAV is a multi-link connector that is maintained in an upwardly curving disposition prior to being latched and that is configured to embrace the at least one downwardly spaced bar of the latchable structure when being latched.

In one aspect, the latching mechanism is adapted to assist the first UAV in landing onto a landing platform, whereby the cable is wound about a spool mounted to the landing platform and a winch operatively connected to the spool is activatable following a latching operation to reduce a length of the cable from the spool to the latching mechanism during a landing maneuver.

In one aspect, the cable further comprises a hose through which fuel injectable into the first UAV following a latching operation is flowable.

A UAV landing method comprises the steps of dispatching an escort UAV with which is irremovably connected a latching mechanism towards a landing-initiating UAV, wherein a cable extending from said latching mechanism is movably connected to a landing platform; causing said latching mechanism to be latched to a latchable structure of said landing-initiating UAV; and causing said landing-initiating UAV to land at the landing platform by reducing a length of the cable from said latching mechanism to the landing platform.

### BRIEF DESCRIPTION OF THE DRAWINGS

In the drawings:

FIG. 1 is a schematic illustration of an embodiment of a UAV latching system;

FIG. 1A illustrates operations performed by a controller in conjunction with the system of FIG. 1, according to one embodiment;

FIG. 1B is a schematic illustration of an autopilot system used in conjunction with the system of FIG. 1 and of inputs thereto;

FIG. 2 is a front perspective view of a latching mechanism usable in conjunction with the system of FIG. 1;

FIG. 3 a top perspective view of an escort UAV that is equipped with the latching mechanism of FIG. 2;

FIG. 4 is a method for performing a landing operation with the escort UAV of FIG. 3;

FIG. 5 is a method for performing midair refueling; and

FIG. 6 is a method for performing midair battery exchange.

### DETAILED DESCRIPTION OF THE INVENTION

The landing of an aerial vehicle by a latched VTOL maneuver onto a moving platform is challenging due to the need of aligning and latching the unmanned aerial vehicle (UAV) with the moving platform. When the landing platform undergoes movement in more than one direction, such as a shipboard platform in response to heave, roll, and pitch motions caused by changes in the wind or wave direction, the ability to reliably land is significantly limited. Many times the latching means deployed on the moving platform cannot be successfully targeted and the UAV lands unsuccessfully, for example colliding with the ship or even falling into the ocean.

It has now been discovered that the influence of a moving landing platform can be mitigated or even altogether eliminated by employing an escort UAV that is configured to become latched with a landing-initiating UAV in midair. Instead of being subject to the risk that the landing-initiating UAV will not be successfully latched with a moving platform, the landing-initiating UAV will be assured of being latched with the escort UAV in midair and will then be drawn to the landing platform.

The use of an escort UAV has utility for other missions as well.

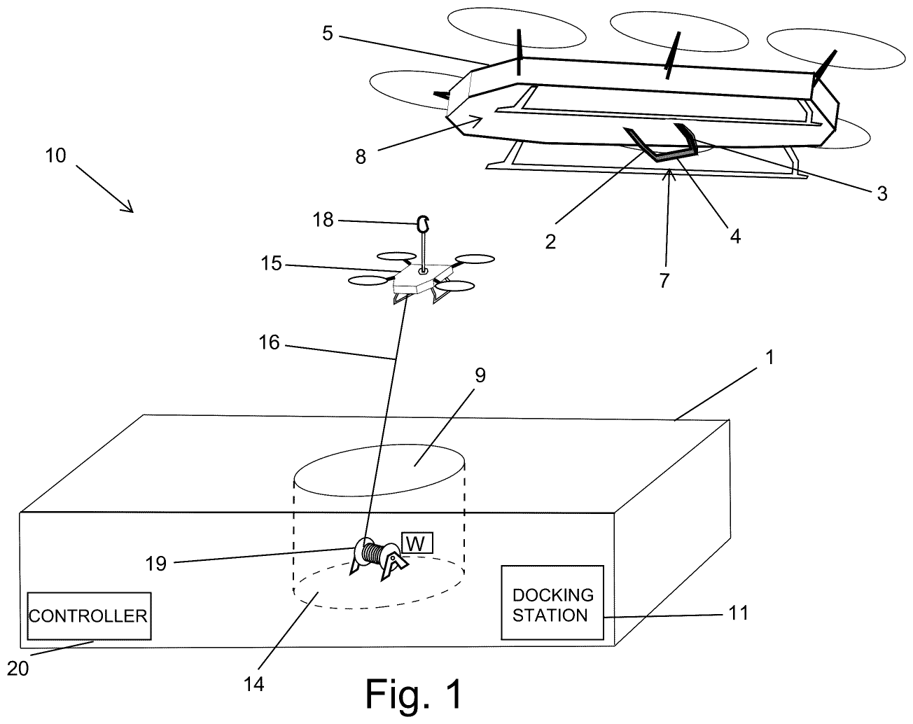

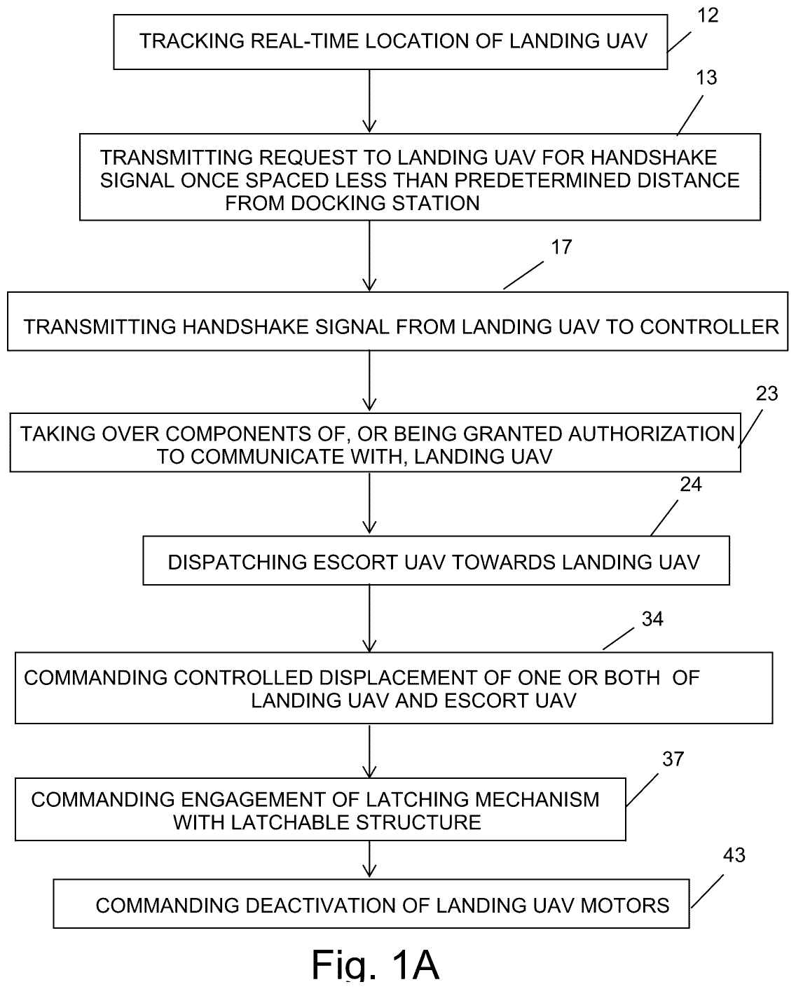

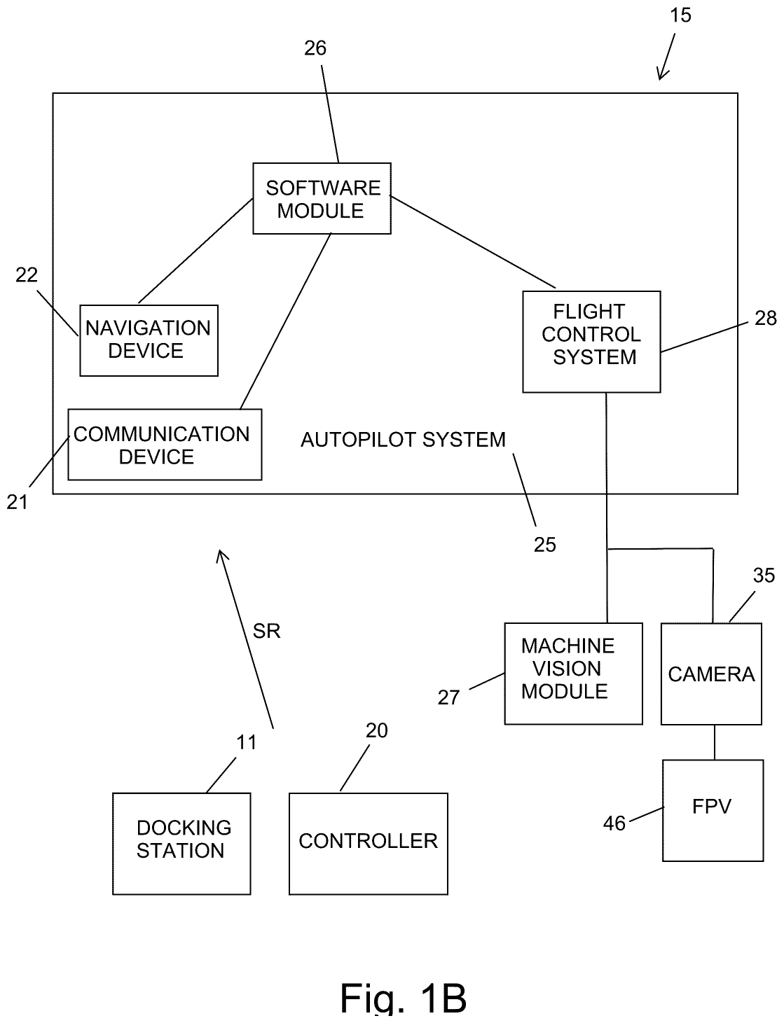

FIG. 1 illustrates a system 10, which may be autonomous, for latching a UAV prior to a landing maneuver onto platform 1, according to one embodiment. Latching system 10 comprises a landing-initiating UAV 5 and a smaller escort UAV 15 adapted to assist landing-initiating UAV 5 during the landing maneuver.

Escort UAV 15 is a small sized aircraft driven by an electric motor, for example a quadcopter, which is permanently tethered to a ground docking station 11 by cable 16 and may have a maximum takeoff weight (MTOW) of approximately 1.5 kg while being able to withstand side winds of up to 30 knots. The estimated carrying weight of escort UAV 15 may be up to 0.5 kg of cable 16. The MTOW of escort UAV 15 is able to be maintained at such a low weight by being equipped without any batteries on board while its motor is powered through the power cable. A typical length of cable 16 is up to 10 m. By virtue of being tethered to docking station 11 by cable 16 as opposed to an extendable arm, the midair stability of escort UAV 15 is advantageously able to be maintained.

A central hub of escort UAV 15 is irremovably connected to a latching mechanism 18. Cable 16 is shown to extend from an undersurface of escort UAV 15, or from a fixture connected thereto, and its first end is movably connected to docking station 11, for example by a spool 19 mounted to the bottom face 14 of landing platform 1 via an aperture 9 formed in the landing platform, or alternatively mounted to its upper face, and about which the cable is wound. The first end of cable 16 is also connected to a power source, such as an electricity grid. A schematically illustrated winch W that is operatively connected to spool 19 controls the extension or retraction of cable 16.

Landing-initiating UAV 5 is configured with a sturdy, downwardly extending latchable structure 7, which is shown to be U-shaped with two spaced bars 2 and 3 extending downwardly and optionally obliquely from the undersurface 8 of UAV 5, and one or two interconnecting bars 4 extending from the end of bars 2 and 3, and connected to each other, such as to form the illustrated U-shaped configuration, but which may assume any other suitable latchable shape as well.

During flight, docking station 11 communicates with landing-initiating UAV 5 and therefore knows its real-time location as well as its intention to land at the docking station. When landing-initiating UAV 5 is spaced less than a predetermined distance from docking station 11, and the landing maneuver is initiated, escort UAV 15 is dispatched upwardly towards landing-initiating UAV 5, which generally hovers at a constant altitude above landing platform 1 of up to 10 m, e.g. 3 m, as determined by an on-board GPS system.

Control commands as to a desired direction of flight are wirelessly transmitted by a short-range signal SR, such as a Bluetooth signal or a WiFi signal, from docking station 11 or controller 20 to the autopilot system 25 (FIG. 1B) of escort UAV 15 during the dispatching operation, so that the escort UAV will approach U-shaped latchable structure 7 from below or from the side to prevent a collision and will subsequently perform a latching operation whereby latching mechanism 18 is set in engaged relation with latchable structure 7. Alternatively, cable 16 comprises an electric power cable and a fiber-optic communication cable adapted to transfer data and control commands without need of a short-range signal. UAV 15, after being tethered to landing platform 1, is pulled towards the platform to ensure safe landing.

A controller 20 deployed in the vicinity of landing platform 1 coordinates the operation of landing-initiating UAV 5 and escort UAV 15. Controller 20 may be mounted on board escort UAV 15 and governs the controlled activation and deactivation of its various motors and components. Alternatively, controller 20 may be stationary, mounted on landing platform 1 or within a structure built on the landing platform or on the docking station, and in wireless communication with the motors and components of UAV 15.

FIG. 1A illustrates the operation of controller 20, according to one embodiment. Docking station 11 tracks the real-time location of landing-initiating UAV 5 in step 12 and updates controller 20 with this information. In order to govern operation of landing-initiating UAV 5, controller 20 may be configured to wirelessly transmit a request for a handshake signal in step 13 once landing-initiating UAV 5 is spaced less than a predetermined distance from docking station 11. Following transmission of the handshake signal in step 17 from landing-initiating UAV 5 to controller 20, in response, the controller temporarily takes over the motors and components of UAV 5 in step 23 and then dispatches escort UAV 15 towards landing-initiating UAV 5 in step 24.

It will be appreciated that controller 20 may command operation of landing-initiating UAV 5 in other ways as well. For example, a short-range control signal SR (FIG. 1B) may be transmitted from controller 20 to a communication device of landing-initiating UAV 5 following transmission of the handshake signal, whereupon the controller is granted authorization to communicate with the landing UAV so as to command controlled displacement of the landing UAV.

Controller 20 commands controlled displacement of one or both of landing-initiating UAV 5 and escort UAV 15 in step 34 until latching mechanism 18 of UAV 15 is set in engaged relation with structure 7 of UAV 5 in step 37, whereupon the motors of landing-initiating UAV 5 are commanded to become deactivated in step 43.

In one embodiment as schematically illustrated in FIG. 1B, the battery-less escort UAV 15 is guided by an onboard autopilot system 25 that is equipped with a real-time kinematic (RTK) accurate GPS-based navigation device 22 that enables it to have a relative GPS (RGPS) capability, with an accuracy of 1 cm relative to landing-initiating UAV 5.

Autopilot system 25 comprises a software module 26 that interfaces with navigation device 22 to determine the real-time position of escort UAV 15 and with a flight control system 28 that is commanded to be suitably operated until escort UAV 15 is guided to latchable structure 7. Software module 26 also interfaces with communication device 21 that is adapted to receive short-range signal SR for guiding escort UAV 15 on a predetermined path, for example after docking station 11 determines the real-time location of landing-initiating UAV 5. As escort UAV 15 needs to be guided by only the short distance from the docking station to landing-initiating UAV, the computer resources of autopilot system 25 may advantageously be limited, allowing the cost of the escort UAV to be likewise reduced.

Alternatively or in addition, escort UAV 15 is navigated in conjunction with a machine vision module 27 or a digital camera 35 that is configured to visualize latchable structure 7 and that may in data communication with flight control system 28. Displacement of escort UAV 15 may be automatically terminated when latchable structure 7 is visualized in response to predetermined instructions. In some embodiments, escort UAV 15 may be remotely navigated by an operator located for example at ground docking station 11 while being able to access the onboard digital camera 35, such as in conjunction with a first-person view (FPV) system 46 that comprises an onboard video transmitter, a ground video receiver and a ground display such as video goggles.

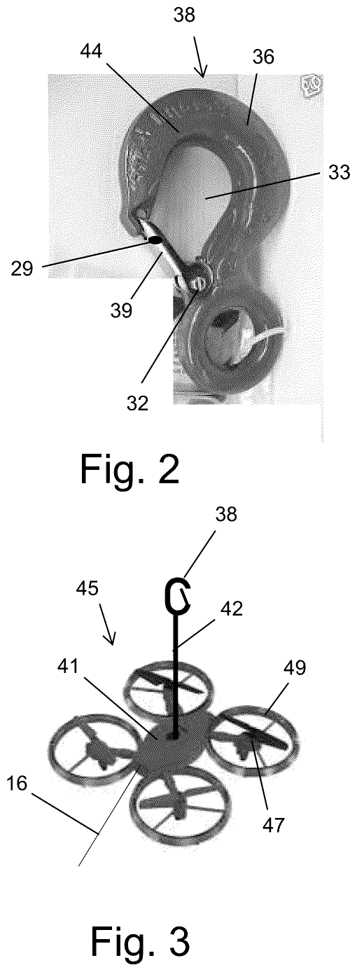

FIG. 2 illustrates a latching mechanism 38, according to one embodiment. In this embodiment, latching mechanism 38 is a hook 36 provided with a spring loaded, inwardly pivoting latch 39, which may have a length of approximately 20 cm and be substantially vertically oriented. Latch 39 is adapted to yield when contacted by the latchable structure, being urged to pivot inwardly about axis 32 into the interior 33 of hook 36. When a bar of the latchable structure is sufficiently introduced into hook interior 33 such that it is spaced between latch 39 and the inner surface of hook body 44, the force applied on the latch is released and the latch is outwardly pivoted about axis 32, its angular displacement being limited by lip 31 until the latch returns to its original position. The hook body 44 may be referred to as a “surrounding element” as it is adapted to surround the bar of the latchable structure when introduced into hook interior 33, and latch 39 may be referred to as a “yielding element” which is in releasable contact with the surrounding element.

Latch 39 may be configured with a schematically illustrated RGPS sensor 29, which is in data communication with controller 20 (FIG. 1) and with a counterpart RGPS sensor mounted on landing-initiating UAV 5, such as housed in one of the bars of latchable structure 7, to sense the relative distance to UAV 5.

It will be appreciated that any other suitable latching mechanism that is configured with a surrounding element and an element that yields and changes its shape upon being contacted by the latchable structure may also be employed. The surrounding element may be configured in many different ways, including a rounded configuration and a rectilinear configuration.

For example, the latching mechanism may be embodied by a multi-link connector extending from the second end of the cable and comprising a plurality of serially extending links, e.g. five links whose total length is 40 cm, wherein each joint of the connector is interconnected with two adjacent links, although any other number of links is also in the scope of the invention. The links are interconnected in such a way that the connector is constantly maintained in an upwardly curving disposition that extends upwardly above the height of the escort UAV, so as to provide an appearance that that connector is seemingly floating in midair while the escort UAV is flying towards the landing-initiating UAV. A terminal link may be provided with a first magnet and the cable-adjoining link may be provided with a second magnet. Following the forcible contact between the latchable structure and the connector, the various links are urged to be angularly displaced until the first and second magnets are coupled together, causing the connector to embrace one or two interconnecting of the latchable structure. An electromechanical lock may be actuated to lock the terminal and the cable-adjoining link together following the latching operation.

FIG. 3 illustrates an exemplary escort UAV 45 that is equipped with latching mechanism 38. A short pole 42, e.g. having a length of approximately 20 cm, extends from hub 41 of escort UAV 45 to latching mechanism 38 located above hub 41 to facilitate the latching operation without interference with its propellers 47. Cable 16 extends downwardly from pole 42, or from hub 41, and is prevented from being entangled with any of the propellers 47 during a landing operation by means of a cylindrical shield 49 having a vertical longitudinal axis that surrounds each propeller.

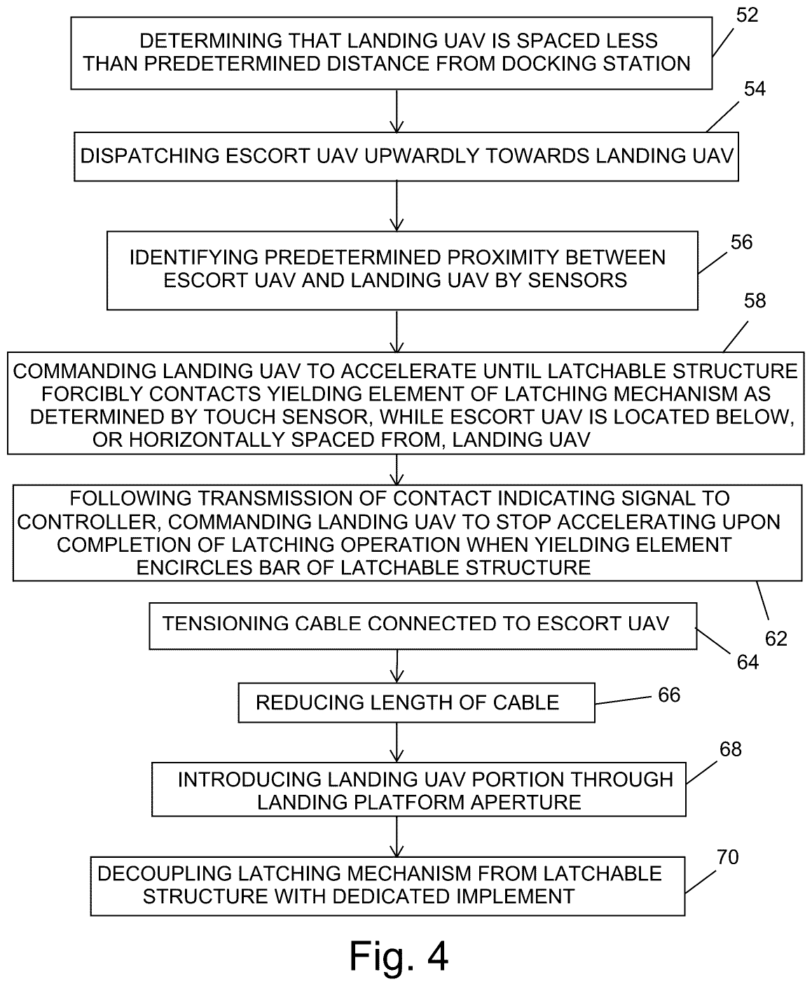

FIG. 4 illustrates an embodiment of a method for performing a landing operation by escort UAV 45 of FIG. 3.

After the docking station determines that the landing-initiating UAV is separated therefrom by less than a predetermined distance in step 52, the controller commands the escort UAV in step 54 to be dispatched upwardly towards the landing-initiating UAV with the assistance of the RPGPS sensors, after lifting off from the landing platform. When the controller identifies in step 56 a predetermined proximity between the landing-initiating UAV and the escort UAV, e.g. up to 10 m, the landing-initiating UAV is commanded to accelerate in step 58 until the latchable structure forcibly contacts the latch of latching mechanism 38 shown in FIG. 3, or the yielding element of any other suitable latching mechanism, to initiate the latching operation, while the escort UAV is located below, or horizontally spaced from, the landing-initiating UAV. The controller determines that forcible contact is made between the latchable structure and the latch of the latching mechanism by means of a touch sensor provided with the latchable structure and the transmission of a corresponding signal between the landing-initiating UAV and the controller, and commands the landing-initiating UAV in return to stop accelerating in step 62 upon completion of the latching operation.

In the next stage, the landing operation is initiated. While the landing-initiating UAV and the escort UAV are latched together, the cable connecting the escort UAV to the landing platform is caused to be tensioned in step 64 when the landing-initiating UAV is commanded to generate constant lift while hovering and simultaneously the winch is activated. Since the cable remains tensioned, it is prevented from becoming entangled with the winch. Suitable rotation of the spool draws the landing-initiating UAV towards the landing platform in step 66 with limited power by reducing the cable length between the spool and the escort UAV.

When the cable length is sufficiently reduced, the landing-initiating UAV approaches the landing platform, and then at least a portion of the landing-initiating UAV in step 68 passes through the aperture formed in the landing platform, which is configured to accommodate and support said portion. For example, the aperture has a plurality of regions, each of which is slightly larger than the contour of a corresponding rotor of the landing-initiating UAV as well as the rotors of the latched escort UAV. Alternatively, the aperture may be a single conical aperture that surrounds all of the rotors. When a dedicated implement forcibly contacts the latch of the latching mechanism afterwards at the landing platform and the escort UAV is subsequently controllably moved laterally, such as by means of special rigging or a movable floor surface, the latching mechanism becomes decoupled from the latchable structure in step 70 in anticipation of a subsequent take-off procedure.

In other embodiments, the escort UAV is able to assist the other UAV (hereinafter “the main UAV”) in performing other midair missions after being latched together. The controller is operable to coordinate operation of the main UAV and the escort UAV to ensure reliable performance of each mission described herein.

Although the following description relates to an UAV, it will be appreciated that the main aerial vehicle may be any VTOL aircraft, such as a multi-rotor, helicopter, and fixed wing aircraft with VTOL capability, whether unmanned or manned.

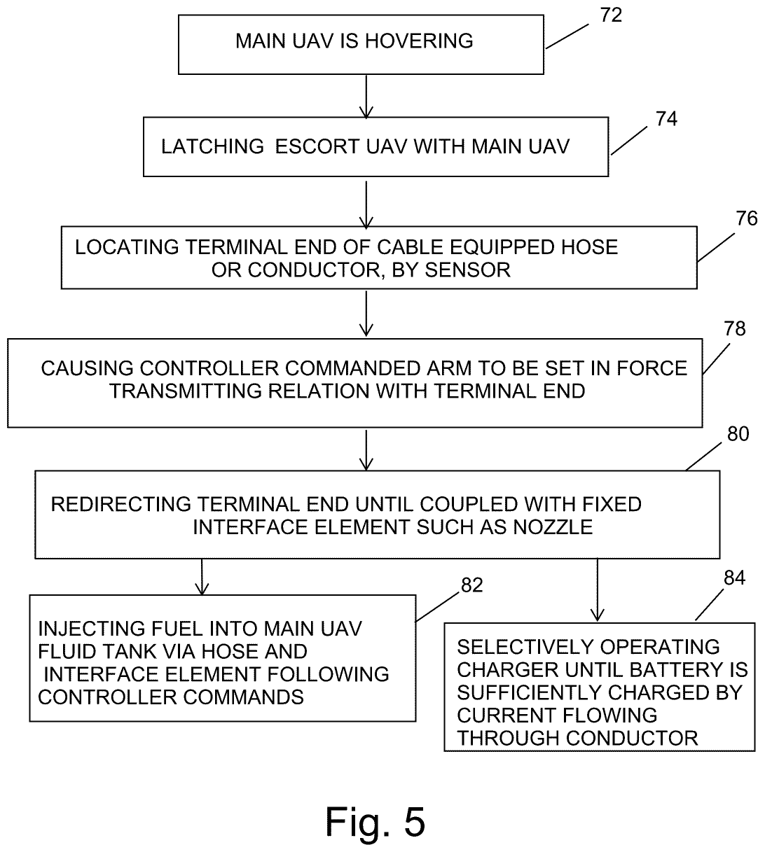

One additional mission that is made possible with the latching operation of the invention is assisting the main UAV in midair refueling, as illustrated in FIG. 5. Thus while the main UAV is hovering in step 72, the escort UAV becomes latched in step 74 with the main UAV by means of latchable structure 7 of FIG. 1 or by means any other suitable latchable structure, such as one adjacent to a main UAV region that needs to be interfaced in order to subsequently perform the midair refueling operation. In this embodiment, the cable connected to the docking station is hollow and comprises an inner hose generally fixedly attached to the outer cable layer, through which fuel needed by the main UAV is flowable. An electric power cable for powering the escort UAV and a fiber-optic communication cable adapted to transfer data and control commands to the escort UAV may be embedded within the outer cable layer while being suitably isolated from the fuel flowing through the hose, such as when the cable and/or hose is made of an electrically isolating material. Alternatively, the motor of the escort UAV may be powered by an on board battery and controlled by remote wireless commands.

Following the latching operation whereby the yielding element of the latching mechanism, or an entire hook, encircles an interconnecting bar of the latching structure and the yielding element is able to be freely displaced along the length of the interconnecting bar, an additional latching operation is performed to center the cable and to couple it with a fixed interface element provided with the main UAV. In this additional latching operation, an arm in data communication with the controller redirects the terminal end of the cable, such as by an electromagnetic actuator or by mechanical engagement, towards the interface element and causes the terminal end to be coupled with the interface element. The interface element may be a protruding element protruding from a body element of the main UAV and equipped with a nozzle at the other unseen end in fluid communication with the fluid tank of the main UAV. The female end of the hose, upon being redirected by the arm to encircle the protruding element, becomes mechanically engaged with the protruding element, such as with a spring loaded releasable arrangement. Alternatively, the terminal end of the hose may be provided with the nozzle and caused by the arm to be inserted into an interface cavity of the main UAV that is in fluid communication with the fluid tank.

It will be appreciated that only the arm assisted latching operation may be performed without need of a latching operation in conjunction of the U-shaped latchable structure.

The arm, which may be configured with a plurality of interconnected links, a telescopic body, and/or a pivotally connected end effector, may be movably connected to the main UAV casing and be equipped with a suitable sensor such as a touch sensor, RGPS sensor and an image processing sensor in data communication with the controller and adapted to suitably locate the terminal end of the hose in step 76, whereupon the arm becomes engaged with the terminal end in step 78, or in force transmitting relation therewith, and redirects it into the interface cavity in step 80 and then the controller commands injection of the fuel through the hose, nozzle and fuel tank in step 82. Alternatively, the arm may be movably connected to the escort UAV casing or hub.

Another mission that is made possible with the latching operation of the invention is assisting the main UAV to perform midair recharging. In this embodiment, a conductor which is electrically connected to a charger mounted at the docking station is embedded within the cable. An electric connection is able to be made with the main UAV battery when the terminal end of the hose is coupled with the interface element in step 80, whereupon the charger is selectively operated in step 84 until the main UAV battery is sufficient charged. An electric power cable for powering the escort UAV and a fiber-optic communication cable adapted to transfer data and control commands to the escort UAV may be embedded within an outer cable layer, or otherwise separated from the charger-connected conductor.

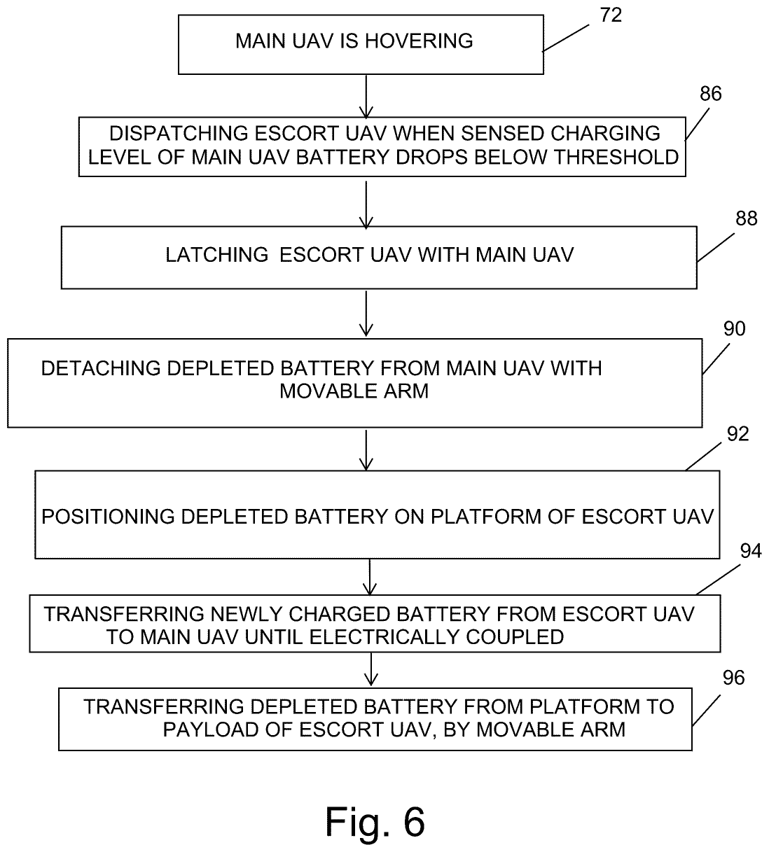

Another mission that is made possible with the latching operation of the invention is assisting the main UAV in midair battery exchanging, as illustrated in FIG. 6. When the payload of the escort UAV includes a newly charged battery and the main UAV is hovering in step 72, the escort UAV is dispatched when a sensor on board the main UAV which is configured to dynamically detect the remaining charge on the main UAV battery updates the controller in step 86 that the charging level has dropped below a predetermined threshold. This step of course is also applicable to a midair recharging mission. Following the latching operation in step 88, the previously described arm in data communication with the controller is adapted to detach the depleted battery from the main UAV in step 90 and position it on a platform of the escort UAV in step 92. The arm then transfers the newly charged battery from the payload of the escort UAV to a socket of the main UAV in step 94, whereat it is electrically coupled. The arm subsequently transfers the depleted battery from the platform to the payload of the escort UAV in step 96 and then couples the depleted battery. The batteries may be configured with a suitable component with which the movable arm is in force transmitting relation to facilitate a transfer operation.

Similar apparatus may be employed when it is desired to transfer a payload from a ground docking station to the midair main UAV.

By performing a midair latching operation, valuable time and resources are advantageously able to be saved in avoiding the need of the main UAV in having to land at a docking station in order to perform any of the missions described above.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A system for latching an unmanned aerial vehicle (UAV), comprising:
a) a first UAV adapted to perform a mission, wherein the first UAV is configured with a latchable structure which comprises two spaced bars that downwardly extend from an undersurface of the first UAV and at least one interconnecting bar which is interconnected between an end of each of said two spaced bars;
b) a second UAV adapted to assist the first UAV in performing the mission, upon being latched together with the first UAV, wherein the second UAV is irremovably connected to a latching mechanism which is configured with a surrounding element and with an element in releasable contact with the surrounding element that yields and changes its shape from a first shape to a second shape upon being contacted by the at least one interconnecting bar of the latchable structure to initiate a latching operation therewith;
c) a cable movably connected to a ground station that extends to, and powers, the second UAV; and
d) a controller operable to dispatch the second UAV upwardly from the ground station toward the first UAV and to command latching of the latching mechanism connected to the second UAV with the latchable structure of the first UAV in midair while the second UAV is located below, or horizontally spaced from, the first UAV during the latching operation,
wherein, following the latching operation, the yielding element assumes the first shape and is configured to, together with the surrounding element, to encircle the at least one interconnecting bar of the latchable structure and to be freely displaceable along a length of at least one interconnecting bar.

2. The system according to claim 1, wherein the latching mechanism comprises a hook provided with a spring loaded, inwardly pivoting latch and a post downwardly extending from the hook to a hub of the second UAV, the latch being configured to yield upon being contacted by the at least one interconnecting bar of the latchable structure to initiate a latching operation therewith.

3. The system according to claim 1, wherein the second UAV is considerably smaller than the first UAV and is powered without batteries.

4. The system according to claim 3, wherein the latching mechanism is adapted to assist the first UAV in landing onto a landing platform.

5. The system according to claim 4, wherein the cable is wound about a spool mounted to the landing platform and a winch operatively connected to the spool is activatable following the latching operation to reduce a length of the cable from the spool to the second UAV during a landing maneuver.

6. The system according to claim 1, wherein the controller is operable to command operation of the first UAV to cause forcible contact between the at least one interconnecting bar of the latchable structure and the yielding element of the latching mechanism when the first UAV is separated less than a predetermined distance from the ground station.

7. A UAV landing method, comprising the steps of:
a) providing a first UAV configured with a latchable structure which comprises two spaced bars that downwardly extend from an undersurface of said first UAV and at least one interconnecting bar which is interconnected between an end of each of said two spaced bars;
b) providing a second UAV irremovably connected to a latching mechanism which comprises a surrounding element and with an element in releasable contact with the surrounding element that yields and changes its shape upon being contacted by the at least one interconnecting bar of the latchable structure to initiate a latching operation therewith, wherein a cable extending from an underside of said second UAV to power said second UAV is movably connected to a landing platform of a ground station;
c) by a controller in data communication with said first UAV, said second UAV and a winch operatively connected to a spool mounted to the landing platform and about which the cable is wound, upon determining that said first UAV is separated from the ground station by less than a predetermined distance, dispatching said second UAV upwardly from the ground station towards said first UAV;
d) by said controller, commanding controlled displacement of one or both of said first UAV and said second UAV while said second UAV is located below, or horizontally spaced from, said first UAV until the yielding element of said latching mechanism is contacted in midair by the at least one interconnecting bar of the latchable structure and the yielding element together with the surrounding element encircle the at least one interconnecting bar, to complete the latching operation between said first UAV and said second UAV; and
e) by said controller, causing said first UAV to land at the landing platform by commanding operation of the winch to reduce a length of the cable from said second UAV to the landing platform.

8. The method according to claim 7, wherein the step of commanding controlled displacement of one or both of said first UAV and said second UAV is performed by commanding the first UAV to accelerate until the at least one interconnecting bar forcibly contacts the yielding element of the latching mechanism and the shape of the yielding element is changed in response to the forcible contact, urging the yielding element together with the surrounding element to encircle the at least one interconnecting bar.

9. The method according to claim 8, wherein the controller temporarily takes over motors and components of the first UAV until the at least one interconnecting bar forcibly contacts the yielding element of the latching mechanism.

10. The method according to claim 9, wherein the controller determines that forcible contact is made between the at least one interconnecting bar and the latch with use of a touch sensor provided with the latchable structure that transmits a corresponding signal to the controller upon being forcibly contacted.

11. The method according to claim 8, further comprising the step of commanding the first UAV, by the controller, to stop accelerating upon completion of the latching operation.

12. The method according to claim 7, wherein all steps are performed autonomously.

13. The method according to claim 7, further comprising the step of causing the latching mechanism to become decoupled from the latchable structure at the landing platform in anticipation of a subsequent take-off procedure by applying a force onto a dedicated implement that initiates additional forcible contact with the yielding element, whereby the shape of the yielding element is changed in response to the additional forcible contact until the yielding element ceases to encircle the at least one interconnecting bar.
